(19) United States
(12) Patent Application Publication
(10) Pub. No.: US 2025/0123579 A1
(43) Pub. Date: Apr. 17, 2025

(54) IMAGE FORMING APPARATUS

(71) Applicant: KYOCERA Document Solutions Inc., Osaka (JP)

(72) Inventors: Kazuki NAKAI, Osaka (JP); Yoshihiro YAMAGISHI, Osaka (JP); Tamotsu SHIMIZU, Osaka (JP); Shiori KIHARA, Osaka (JP); Shinya SAKAOKA, Osaka (JP)

(73) Assignee: KYOCERA Document Solutions Inc., Osaka (JP)

(21) Appl. No.: 18/911,965

(22) Filed: Oct. 10, 2024

(30) Foreign Application Priority Data
Oct. 17, 2023 (JP) 2023-178678

(51) Int. Cl. G03G 15/08; G03G 21/18

(52) U.S. Cl. CPC G03G 15/0865; G03G 15/0863; G03G 21/1814; G03G 2215/0695

(57) ABSTRACT

An image forming apparatus includes an image forming portion, a toner storage container, an odor generator, an odor sensor, and a control portion. The image forming portion includes an image carrying member and a development device that develops an electrostatic latent image formed on the image carrying member into a toner image, and forms the toner image based on image data. The toner storage container stores toner for forming the toner image, and is removably mountable in a main body of the image forming apparatus. The odor generator is provided on the toner storage container, and carries an odor substance. The odor sensor is provided in the main body of the image forming apparatus, and senses the odor substance diffusing from the odor generator. The control portion identifies the type of toner storage container based on the odor substance sensed by the odor sensor.

### INCORPORATION BY REFERENCE

This application is based on and claims the benefit of priority from Japanese Patent Application No. 2023-178678 filed on Oct. 17, 2023, the contents of which are hereby incorporated by reference.

### BACKGROUND

The present disclosure relates to image forming apparatuses that employ an electrophotographic process, such as copiers and printers, and relates in particular to image forming apparatuses that include a toner storage container that is removably mountable in the image forming apparatus.

Image forming apparatuses that employ an electrophotographic process, such as copiers, printers, and facsimiles, typically use powder developers and commonly employ a process in which an electrostatic latent image formed on an image carrying member such as a photosensitive drum is made visible with toner in a development device and the toner image is transferred onto a recording medium directly or via an intermediate transferring member to be then subjected to fixing.

To reduce the size of the development device, a method is known in which a replaceable toner storage container such as a toner container or a toner cartridge is used to supply toner from outside the development device according to the amount of toner remaining in the development device.

In general, for the toner storage container, print quality is guaranteed through the use of consumables recommended by the vendor of the image forming apparatus (hereinafter referred to as genuine products). For consumables from other than the vendor of the image forming apparatus (hereinafter referred to as non-genuine products), the vendor does not guarantee print quality and does not provide equipment maintenance. However, since many non-genuine products are inexpensive, there are an increasing number of cases where users use non-genuine products despite knowing that they are non-genuine products. As a result, continued use of non-genuine products causes problems such as failure of the image forming apparatus and deterioration of image quality.

### SUMMARY

According to one aspect of the present disclosure, an image forming apparatus includes an image forming portion, a toner storage container, an odor generator, an odor sensor, and a control portion. The image forming portion includes an image carrying member and a development device that develops an electrostatic latent image formed on the image carrying member into a toner image, and forms the toner image based on image data. The toner storage container stores toner for forming the toner image, and is removably mountable in a main body of the image forming apparatus. The odor generator is provided on the toner storage container, and carries an odor substance. The odor sensor is provided in the main body of the image forming apparatus, and senses the odor substance diffusing from the odor generator. The control portion identifies the type of toner storage container based on the odor substance sensed by the odor sensor.

### BRIEF DESCRIPTION OF THE DRAWINGS

FIG. 1 is a schematic configuration diagram of a color printer according to one embodiment of the present disclosure.

FIG. 2 is a plan view, as seen from above, of a toner container used in a color printer according to a first embodiment of the present disclosure.

FIG. 3 is a side view showing a state of the toner container mounted in a container mounting portion.

FIG. 4 is a sectional view, as seen from upstream in the insertion direction, around an odor generator on the toner container mounted in the container mounting portion.

FIG. 5 is a side view showing a configuration where the odor generator faces an odor sensor during insertion of the toner container into the container mounting portion.

FIG. 6 is a block diagram showing control paths used in the color printer of the first embodiment.

FIG. 7 is a diagram showing, as a modified example of the color printer of the first embodiment, a configuration in which one odor sensor moves to sense the odor generators on the toner containers.

FIG. 8 is a plan view, as seen from above, of another example of the toner container in the color printer of the first embodiment, showing a configuration in which the toner container includes two odor generators.

FIG. 9 is a side sectional view of a toner container and a toner supplying path used in a color printer according to a second embodiment of the present disclosure.

FIG. 10 is a side view of a toner container used in a color printer according to a second embodiment, and shows an example in which an odor generator is arranged on a fixing portion.

FIG. 11 is a side view of the toner container used in the color printer according to the second embodiment, and shows an example in which the odor generator is arranged on a bottom surface of a container body.

FIG. 12 is a rear view of the color printer.

FIG. 13 is a side view of yet another example of the toner container mounted in the color printer of the second embodiment.

FIG. 14 is a plan view showing an example in which a protection member is provided on the odor generator.

FIG. 15 is a plan view showing another example in which a protection member is provided on the odor generator.

FIG. 16 is a top view of the toner container having a label-type odor generator arranged on the outer circumferential surface of the container body.

FIG. 17 is a schematic diagram of an odor generator configured with superabsorbent beads.

### DETAILED DESCRIPTION

### [1. Overall Configuration of Image Forming Apparatus]

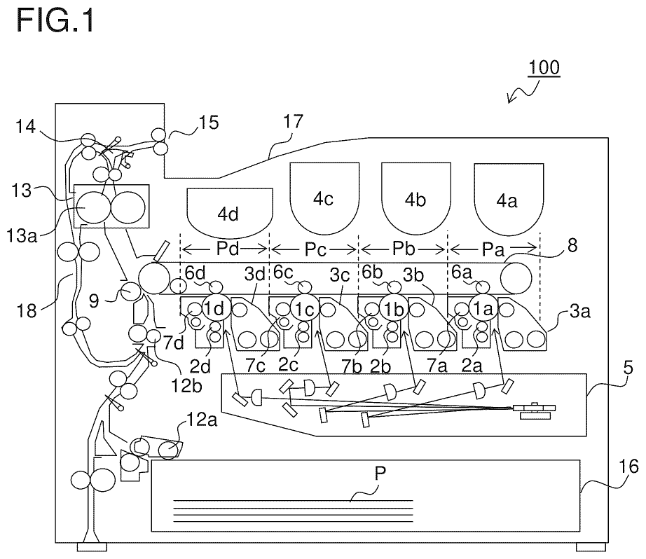

Hereinafter, an embodiment of the present disclosure will be described with reference to the drawings. FIG. 1 is a schematic sectional view of an image forming apparatus according to an embodiment of the present disclosure, showing a tandem color printer. In a main body of a color printer 100, four image forming portions Pa, Pb, Pc, and Pd are arranged in this order from upstream (the right side in FIG. 1) in the conveyance direction. The image forming portions Pa to Pd are provided so as to correspond to images of four different colors (yellow, cyan, magenta, and black). The image forming portions Pa to Pd form yellow, cyan, magenta, and black images sequentially, each through the processes of electrostatic charging, exposure to light, image development, and image transfer.

In these image forming portions Pa to Pd are arranged photosensitive drums 1a, 1b, 1c, and 1d, which carry visible images (toner images) of the different colors. An intermediate transfer belt 8 that rotates clockwise in FIG. 1 is provided adjacent to the image forming portions Pa to Pd. A secondary transfer roller 9 is provided adjacent to the intermediate transfer belt 8.

When image data is fed in from a host device such as a personal computer, first, charging devices 2a to 2d electrostatically charge the surfaces of the photosensitive drums 1a to 1d uniformly. Next, an exposure device 5 irradiates the photosensitive drums 1a to 1d with light according to the image data to form on them electrostatic latent images according to the image data. Development devices 3a to 3d are loaded with predetermined amounts of two-component developer (hereinafter, also referred to simply as developer) containing toner of different colors, namely yellow, cyan, magenta, and black respectively, supplied from toner container 4a to 4d. The toner in the developer is fed from the development devices 3a to 3d to the photosensitive drums 1a to 1d and electrostatically adheres to them. Thus, toner images are formed according to the electrostatic latent images formed by exposure to light from the exposure device 5.

Then, primary transfer rollers 6a to 6d apply an electric field at a predetermined transfer voltage between the primary transfer rollers 6a to 6d and the photosensitive drums 1a to 1d, and thereby the yellow, cyan, magenta, and black toner images on the photosensitive drums 1a to 1d are primarily transferred to the intermediate transfer belt 8. The toner and the like remaining on the surfaces of photosensitive drums 1a to 1d after primary transfer are removed by cleaning devices 7a to 7d.

A transfer sheet P to which the toner images are to be transferred is stored inside a sheet cassette 16 arranged in a bottom part of the color printer 100. The transfer sheet P is conveyed from the sheet cassette 16 via a sheet feed roller 12a and a pair of registration rollers 12b to a nip portion (a secondary transfer nip portion) between the secondary transfer roller 9 and the intermediate transfer belt 8 with predetermined timing. The transfer sheet P having the toner images secondarily transferred to it is conveyed to a fixing portion 13.

The transfer sheet P conveyed to the fixing portion 13 is heated and pressed by the pair of fixing rollers 13a; thus the toner images are fixed to the surface of the transfer sheet P and a predetermined full-color image is formed. The transfer sheet P having the full-color image formed on it is discharged as it is (or after being diverted to a duplex conveyance passage 18 by a branching portion 14 to have images formed on both sides) to a discharge tray 17 by a pair of discharge rollers 15.

### [2. Identifying Non-Rotating Toner Container by Use of Odor Sensor]

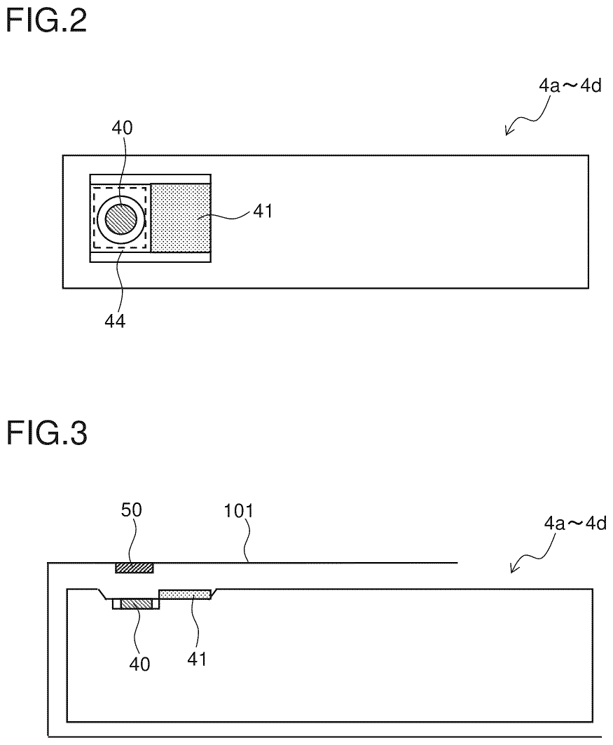

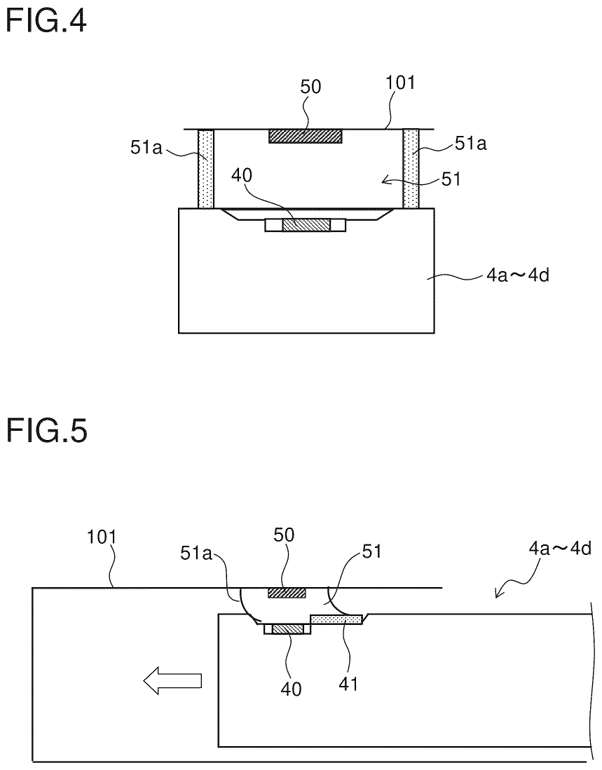

FIG. 2 is a plan view, as seen from above, of the toner containers 4a to 4d used in the color printer 100 according to a first embodiment of the present disclosure. FIG. 3 is a side view showing the state of the toner containers 4a to 4d mounted in a container mounting portion 101. FIG. 4 is a sectional view, as seen from upstream in the insertion direction, around an odor generator 40 on the toner containers 4a to 4d mounted in the container mounting portion 101. The toner containers 4a to 4d have basically a similar structure, so one of the toner containers 4a to 4d is shown as a representative in FIGS. 2 to 4.

In the color printer 100 of this embodiment, the odor sensor 50 senses odor substances diffusing from the odor generators 40 on the toner containers 4a to 4d to identify the toner containers 4a to 4d. Specifically, based on the odor substances sensed by the odor sensor 50, whether the toner containers 4a to 4d are genuine products is judged. By using different odor substances for the different colors corresponding to the toner containers 4a to 4d, the color and type of the toner contained in the toner containers 4a to 4d can be identified.

According to this embodiment, by identifying the toner containers 4a to 4d by sensing odor substances that are difficult to imitate, it is possible to identify the types of the toner containers 4a to 4d more accurately and easily than by physical or electrical identification methods such as wireless tags, which can be easily counterfeited. There is no need to add an odor to the toner itself, and this eliminates the risk of a strong odor from images printed with a high print ratio. To follow is a description of a configuration around the odor generator 40 and the odor sensor 50, identification of the toner containers 4a to 4d, and a control procedure for the color printer 100 using identification results.

As shown in FIG. 2, on the top face of the tonner containers 4a to 4d, there are provided the odor generator 40, a shutter 41, and a sealing member 44. The odor generator 40 is composed of a base material of a nonwoven fabric or like impregnated with an odor substance. Used as the base material is, for example, a long-fiber nonwoven fabric made of polypropylene or a nonwoven fabric made by directly spinning a polymer of which the main component is sodium polyacrylate.

Specifically, the odor substance is an organic compound that contains a carbon atom and at least one of a hydrogen atom, a nitrogen atom, an oxygen atom, and a sulfur atom and that, with a molecular weight of approximately 20 to 400, evaporates at room temperature (room-temperature-volatile). It may be a compound of which the odor humans cannot smell. Specific examples of compounds usable as odor substances include nerolidol, y-decalactone, ethyl maltol, anisole, stabilized chlorine dioxide, odorless petroleum, linalool, terpineol, allylic ester, sesquiterpene, and green-tea catechin. Examples of compounds of which the odor humans cannot smell include cyclodextrin.

The shutter 41 is slidably attached to the top face of the toner containers 4a to 4d. In a state where the toner containers 4a to 4d are removed from the color printer 100, the shutter 41 is arranged in a closed position in which it covers the odor generator 40. This makes it possible to prevent the odor from diffusing from the odor generator 40. When the toner containers 4a to 4d are mounted in the container mounting portion 101 in the color printer 100, as shown in FIGS. 2 and 3, the shutter 41 moves to an open position in which it leaves the odor generator 40 open.

The sealing member 44 is formed of a material that is impermeable to the odor substance impregnated in the odor generator 40 and prevents the diffusion of the odor substance during transportation and storage of the toner containers 4a to 4d. When the toner containers 4a to 4d are used, as shown in FIG. 3, after the sealing member 44 is peeled off, the toner containers 4a to 4d are inserted into the container mounting portion 101.

In the container mounting portion 101, the odor sensor 50 is arranged at a position facing the odor generator 40. The odor sensor 50 senses the odor substance diffusing from the odor generator 40. The odor sensor 50 will be described in detail later.

As shown in FIG. 4, in a state where the toner containers 4a to 4d are mounted in the container mounting portion 101, an odor retention portion 51 is formed that surrounds a space including the odor generator 40 and the odor sensor 50. The odor retention portion 51 is provided separately one for each of the toner containers 4a to 4d. More specifically, partition walls 51a are provided so as to surround the odor sensor 50 and an opening is formed only in the surface (the lower surface in FIG. 4) facing the toner containers 4a to 4d. When the toner containers 4a to 4d are mounted, with the odor generator 40 inserted in the opening, the partition walls 51a come into contact with the toner containers 4a to 4d and form the odor retention portions 51.

This allows the odor sensor 50 to sense only the odor substance from the corresponding odor generator 40 without being affected by the odor substance diffusing from the odor generator 40 of the adjacent toner containers 4a to 4d. It is thus possible to enhance the sensing accuracy of the odor sensor 50.

While FIG. 3 shows a configuration where, in a state where the toner containers 4a to 4d are mounted, the odor generator 40 faces the odor sensor 50, instead, as shown in FIG. 5, the odor sensor 50 may be arranged in a middle part of the container mounting portion 101 and the odor generator 40 may face the odor sensor 50 during insertion of the toner containers 4a to 4d.

In the configuration in FIG. 5, the shutter 41 moves to the open position when the toner containers 4a to 4d pass through the middle part of the container mounting portion 101 and returns to the closed position after the toner containers 4a to 4d are mounted. To prevent interference with the movement of the toner containers 4a to 4d and to prevent damage to the odor sensor 50, it is preferable that the partition walls 51a forming the odor retention portion 51 be formed of an elastic material, a flexible sheet material (urethane seal) or the like. To sense the odor substance from the odor generator 40, the toner containers 4a to 4d may be temporarily stopped while passing through the middle part of the container mounting portion 101 but, if the sensitivity of the odor sensor 50 is high, do not need to be stopped.

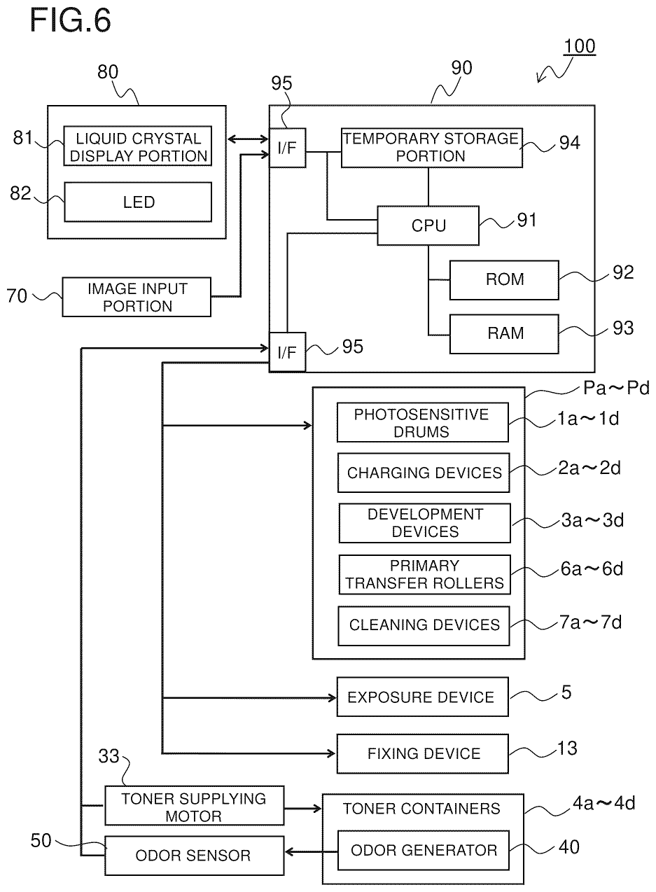

FIG. 6 is a block diagram showing one example of control paths used in the color printer 100 of the first embodiment. The control paths in the entire color printer 100 are complicated because various kinds of control are performed in different parts of the apparatus when the color printer 100 is in use. For simplicity's sake, the following description will focus on those control paths that are necessary for implementing the present disclosure. For such parts as have already been described, a simplified or no description will be given.

An image input portion 70 is a reception portion that receives image data transmitted from a personal computer or the like to the color printer 100. An image signal input from the image input portion 70 is converted into a digital signal and is then sent to a temporary storage portion 94. If the image forming apparatus is a copier or a digital multifunction peripheral, the image input portion 70 corresponds to an image reading portion that reads a document image and converts it into image data.

An operation portion 80 is provided with a liquid crystal display portion 81 and LEDs 82 that indicate various states, and indicates the status of the color printer 100, the progress of image formation, and the number of copies printed. Various settings for the color printer 100 are made from a printer driver on the personal computer.

The operation portion 80 is also provided with a start button that is used when the user enters an instruction to start image formation, a stop/clear button that is used to cancel image formation, and a reset button that is used to get the various settings on the color printer 100 back to the default ones.

The odor sensor 50 senses the odor substance diffusing from the odor generator 40 fitted to the toner containers 4a to 4d and judges whether the toner containers 4a to 4d are genuine or non-genuine products as well as the color, type, and the like of the toner contained in the toner containers 4a to 4d. The information acquired by the odor sensor 50 is stored in a RAM 93.

The odor sensor 50 can be of any type, such as a semiconductor type, a quartz oscillator type, or a membrane-type surface stress (MSS) type; among these, a quartz oscillator type with a sensitive membrane attached to it or a membrane-type surface stress type can sense a plurality of different odors, allowing highly accurate discrimination.

The semiconductor type can be an oxide semiconductor type or an organic semiconductor type. The sensing of odors by the semiconductor-type odor sensors 50 exploits the change in the resistance value of the semiconductor resulting from the molecules of the odor substance being adsorbed onto the semiconductor surface. The quartz crystal oscillator type can be one that uses a natural lipid or one that uses a synthetic lipid. The quartz crystal oscillator type odor sensor 50 has a structure in which an odor-sensing membrane is attached to the surface of an oscillator. When the molecules of the odor substance are adsorbed onto the sensing membrane, the mass of the membrane increases and the resonant frequency of the quartz crystal oscillator decreases. From the amount of this decrease, the mass of the molecules of the odor substance is measured. With the quartz crystal oscillator type, the odor substance that can be sensed changes depending on the type of sensing membrane.

Usable as the odor sensor 50 with necessary improvements made is, for example, as a semiconductor type, XP-329III (manufactured by New Cosmos Electric Co., Ltd.) or OMX-SR (manufactured by Shin-ei Co., Ltd.), or, as a quartz oscillator type, noseStick (manufactured by I-PEX Co., Ltd.).

The control portion 90 at least includes a CPU (central processing unit) 91 as a central arithmetic processor, a ROM (read-only memory) 92 as a read-only storage portion, a RAM (random-access memory) 93 as a readable and rewritable storage portion, a temporary storage portion 94 that temporarily stores image data and the like, and a plurality of (here, two) I/Fs (interfaces) 95 that transmit control signals to different blocks in the color printer 100 and receive input signals from an operation portion 80.

The ROM 92 stores a control program for the color printer 100 as well as data that are not changed during the use of the color printer 100, such as values necessary for control. The RAM 93 stores necessary data generated in controlling the color printer 100, data temporarily required in controlling the color printer 100, and the like. The temporary storage portion 94 temporarily stores the image signal input from the image input portion 70 and converts it into a digital signal.

The control portion 90 transmits control signals from the CPU 91 via the I/Fs 95 to different parts and blocks in the color printer 100. From those parts and blocks, signals indicating their states and input signals are transmitted via the I/Fs 95 to the CPU 91. Examples of the parts and blocks controlled by the control portion 90 include the image forming portions Pa to Pd, the exposure device 5, the fixing portion 13, the image input portion 70, and the operation portion 80.

The control portion 90 can use information about the toner containers 4a to 4d that is acquired by the odor sensor 50 and stored in the RAM 93 to control the color printer 100. For example, by outputting the information stored in the RAM 93 to the liquid crystal display portion 81 and referring to it on the occasion of a failure or the like of the color printer 100, it is possible to expedite the identification of the cause of the failure.

When the toner containers 4a to 4d are identified as genuine or non-genuine products, the control portion 90 changes the image forming conditions according to the identified toner containers 4a to 4d as necessary. For example, if the toner containers 4a to 4d are non-genuine products and the image density is lower than the target value, the control portion 90 changes the image forming conditions as by increasing the development voltage.

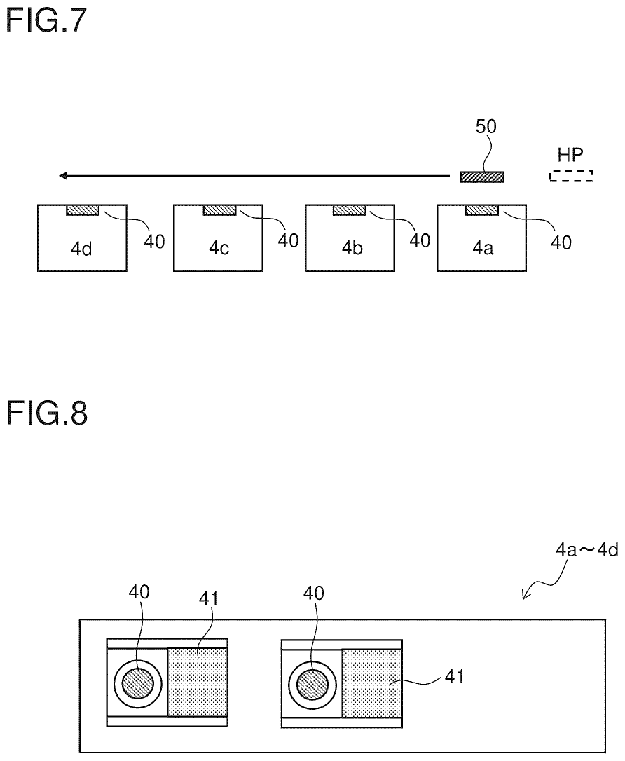

FIG. 7 is a diagram showing, as a modified example of the color printer 100 of the first embodiment, a configuration in which one odor sensor 50 moves to sense the odor generators 40 on the toner containers 4a to 4d. The toner containers 4a to 4d are similar in configuration to those shown in FIGS. 2 to 4.

In the configuration in FIG. 7, the odor sensor 50 can move among positions (measurement positions) facing the odor generators 40 on the toner containers 4a to 4d. When sensing the odor substance, the odor sensor 50 is stopped at one after another of the measurement positions to sense the odor substances from the odor generators 40 on the toner containers 4a to 4d.

When not sensing the odor substance, the odor sensor 50 is kept on standby at a position (home position HP) not facing any of the odor generators 40. This makes it difficult for the molecules of the odor substance diffused from the odor generator 40 to reach the odor sensor 50. As a result, the odor sensor 50 can be kept in surroundings low in odor substances, so it is possible to prevent adhesion of odor substances to the odor sensor 50 and to prevent deterioration of the odor sensor 50, thereby extending the life of the odor sensor 50.

When sensing proceeds with the odor sensor 50 moving from one to the next of the odor generators 40 on the toner containers 4a to 4d, it is preferable to move to the open position only the shutter 41 (see FIG. 3) of that one of the toner containers 4a to 4d from which the odor substance is to be sensed, and to arrange the shutters 41 of the other toner containers 4a to 4d in the closed position. This prevents the diffusion of the odor substances from the odor generators 40 from which the odor substances are not to be sensed, thereby enhancing the sensing accuracy of the odor sensor 50 for odor substances.

In the case of a sensitive membrane type odor sensor 50, when it is exposed to dry air after the molecules of the odor substance have adsorbed on the sensitive membrane, the molecules desorb from the sensitive membrane and the sensor 50 returns to its original state. Each time sensing is complete for one odor generator 40, the odor sensor 50 can be moved to the home position HP to be exposed to dry air so that the odor sensor 50 is reset. It is thus possible to continuously and accurately sense the odor substances from the plurality of the odor generators 40. It is also possible to prevent deterioration of the odor sensor 50, leading to an extended life of the odor sensor 50.

When sensing proceeds with the odor sensor 50 moving from one to the next of the odor generators 40 on the toner containers 4a to 4d, the partition walls 51a forming the odor retention portion 51 (see FIG. 4) are formed of an elastic material, a flexible sheet material (urethane seal), or the like. This prevents the odor sensor 50 from being scratched or damaged due to contact with the partition walls 51a.

FIG. 8 is a plan view, as seen from above, of another example of the toner containers 4a to 4d in the color printer 100 of the first embodiment, showing a configuration in which the toner containers 4a to 4d each include two odor generators 40.

Arranging two odor generators 40 on each of the toner containers 4a to 4d permits measurement of two types of odor substances. For example, by using different odor substances in the two odor generators 40, it is possible, with one odor generator 40, to sense whether the toner containers 4a to 4d are genuine or non-genuine products and, with the other odor generator 40, to acquire information such as the color of the toner and the manufacturing date of the toner. Here, two odor generators 40 are provided, but it is also possible to arrange three or more odor generators 40. A plurality of odor sensors 50 may be arranged at positions corresponding to the different odor generators 40, or one odor sensor 50 may be moved so as to sense them.

### [3. Identifying Rotary Toner Container by Use of Odor Sensor]

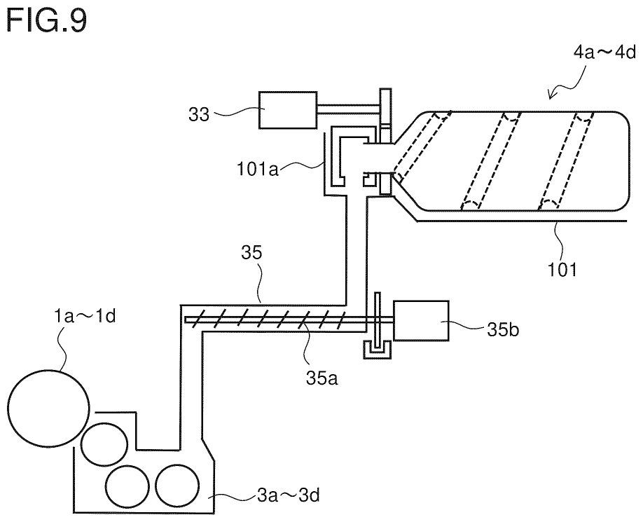

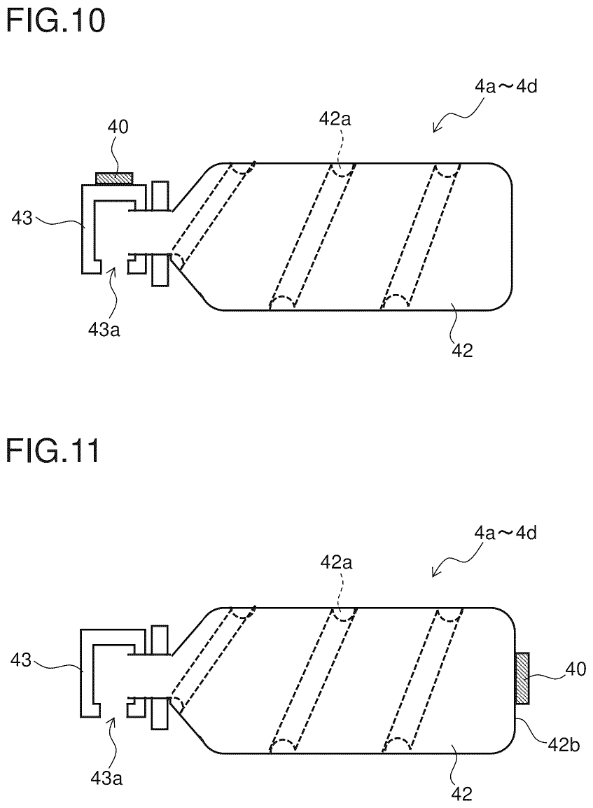

FIG. 9 is a side sectional view of toner containers 4a to 4d and a toner supplying path used in a color printer 100 according to a second embodiment of the present disclosure. FIG. 10 is a side view of the toner containers 4a to 4d used in the color printer 100 according to the second embodiment, and shows an example in which an odor generator 40 is arranged on a fixing portion 43. The toner containers 4a to 4d all have basically a similar structure, so the toner containers 4a to 4d are represented by one of them in FIG. 10, and also in FIG. 11, which will be referred to later. In this embodiment, rotary toner containers 4a to 4d are used; that is, the toner containers 4a to 4d themselves rotate to supply toner.

As shown in FIG. 9, the toner containers 4a to 4d are connected to the development devices 3a to 3d via a toner supplying pipe (sub hopper) 35. The toner supplying pipe 35 is bent in a crank shape. Inside a horizontal part of the toner supplying pipe 35, a conveyance screw 35a is arranged and the toner conveyance screw 35a is coupled to a conveyance motor 35b.

As shown in FIG. 10, the toner containers 4a to 4d each have a container body 42 and a fixing portion 43. The container body 42 is configured to be rotatable about a rotation axis extending in the longitudinal direction. The container body 42 stores toner of each color (not shown). On the inner circumferential surface of the container body 42, a conveyance rib 42a in a spiral shape is continuously provided. The conveyance rib 42a projects inward in the radial direction from the inner circumferential surface of the container body 42.

The fixing portion 43 is mounted on, so as not to be rotatable relative to, a mounting portion 101a (see FIG. 9) in the container mounting portion 101. In the fixing portion 43, a toner discharging port 43a is formed to be coupled to the toner supplying pipe 35. On the top face of the fixing portion 43, the odor generator 40 is arranged.

Referring back to FIG. 9, near the mounting portion 101a, a toner supplying motor 33 is arranged to rotate the container body 42. As the toner supplying motor 33 rotates the container body 42, the toner inside the container body 42 moves toward the fixing portion 43 by the action of the conveyance rib 42a, and then the toner falls from the toner discharging port 43a into the toner supplying pipe 35. The toner that has fallen into the toner supplying pipe 35 is supplied to the development devices 3a to 3d as the conveyance screw 35a rotates.

Arranging the odor generator 40 on the fixed portion 43 of the toner containers 4a to 4d prevents the odor generator 40 from rotating together with the container body 42, and this permits the odor sensor 50 to be fixed and arranged at a position facing the odor generator 40.

As shown in FIG. 11, the odor generator 40 can be arranged at the center of a bottom surface 42b of the container body 42. In this case, the position of the odor generator 40 does not change even if the container body 42 rotates, and this too, as in FIG. 10, permits the odor sensor 50 to be fixed and arranged at a position facing the odor generator 40.

In the configurations of FIGS. 10 and 11, by aligning the orientation of the odor generators 40 on the toner containers 4a to 4d, it is possible, as shown in FIG. 7, to move one odor sensor 50 from one to the next of the positions facing the odor generators 40 to sense the odor substances.

When not sensing the odor substance, as shown in FIG. 7, the odor sensor 50 is kept on standby at a position (home position HP) not facing any of the odor generators 40. As a result, the odor sensor 50 can be kept in surroundings low in odor substances, so it is possible to prevent deterioration of the odor sensor 50, thereby extending the life of the odor sensor 50.

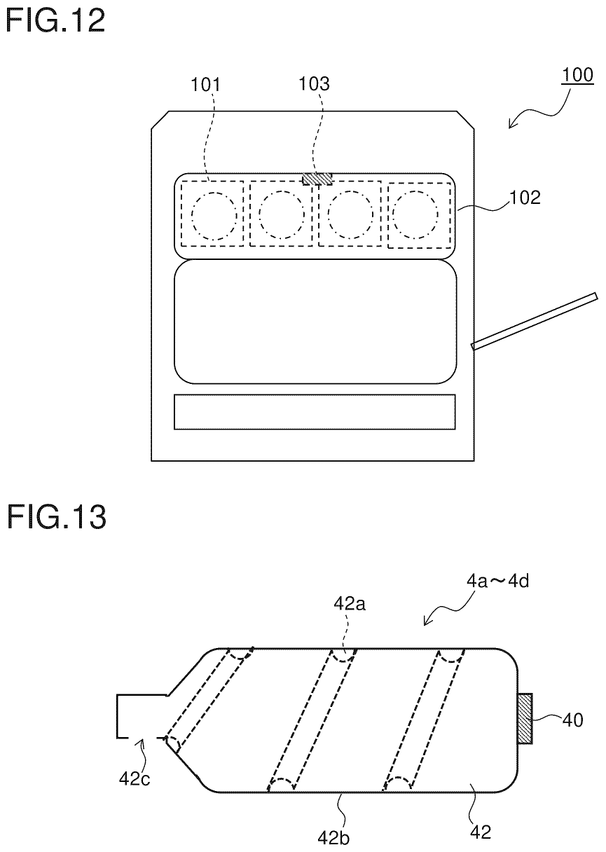

The timing to sense the odor substance with the odor sensor 50 can be when the toner containers 4a to 4d are replaced. The replacement of the toner containers 4a to 4d can be sensed by use of an open/closed signal with respect to a container cover 102, as shown in FIG. 12, that opens and closes the container mounting portion 101 when the toner containers 4a to 4d are inserted or removed. The container cover 102 is provided so as to be openable and closable at the rear of the color printer 100 and the container mounting portion 101 is fitted with, at a position at which it makes contact with the container cover 102, an open/closed sensing switch 103. When the container cover 102 is opened and closed, an open/closed signal is transmitted from the open/closed sensing switch 103 to the control portion 90 (see FIG. 6).

However, when the power to the color printer 100 is off, whether the container cover 102 is open or closed cannot be recognized. To cope with that, assuming that the toner containers 4a to 4d may have been inserted with the power off, the odor substance may be sensed when the power to the color printer 100 is turned on. If the container cover 102 can be locked except when the toner containers 4a to 4d need to be replaced, there is no need to sense the odor substance when the power is turned on.

Instead, the replacement of the toner containers 4a to 4d may be checked by the user. The odor sensing operation after reception of an open/closed signal with respect to the container cover 102 or at the power-on of the color printer 100 may be limited to after occurrence of an empty signal for the toner containers 4a to 4d. If a plurality of toner containers 4a to 4d have been newly mounted, sensing may be performed with the replaced toner containers 4a to 4d rotated simultaneously; or to prevent the influence of the odor generators 40 on the other toner containers 4a to 4d, the odor substance may be sensed with the replaced toner containers 4a to 4d rotated one by one. Table 1 shows an example of situations in which to sense the odor substance and the toner containers targeted for sensing.

TABLE 1

| Situation | Target for sensing |
|---|---|
| At initial installation of color printer | All toner containers |
| At replacement of toner containers | Replaced toner containers |
| At recovery from maintenance | All toner containers |
| At power-on | All toner containers |

### [4. Other Configurations]

FIG. 13 is a side view of yet another example of the toner containers 4a to 4d mounted in the color printer 100 of the second embodiment. The toner containers 4a to 4d shown in FIG. 13 are composed only of a container body 42 and do not have a fixing portion 43 (see FIG. 10). In the container body 42, a toner discharging port 42c is formed. In other respects, the structure here is similar to that of the toner containers 4a to 4d shown in FIG. 10. When toner is supplied, the entire toner containers 4a to 4d rotate and only when the toner discharging port 42c faces down, toner is discharged through the toner discharging port 42c.

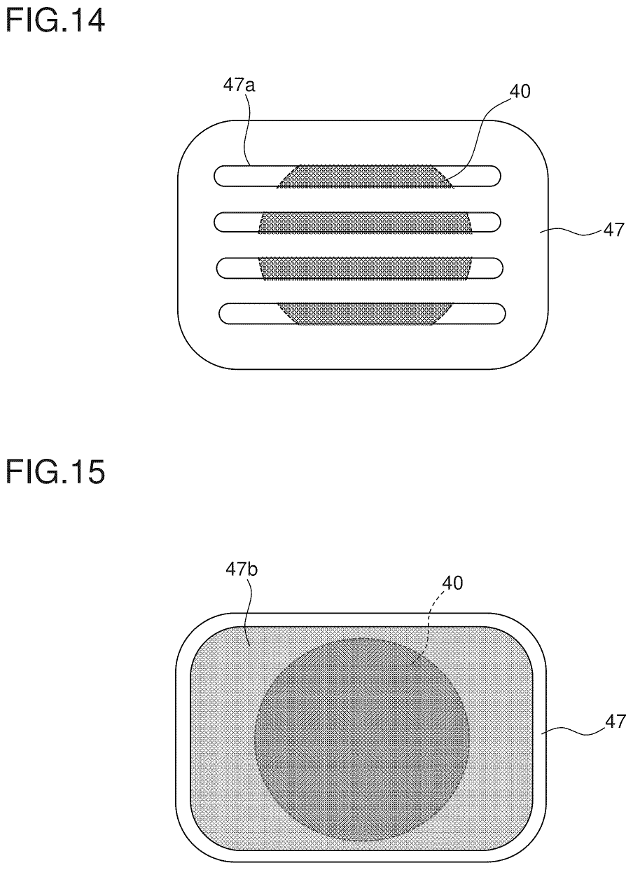

As shown in FIGS. 14 and 15, a protection member 47 may be provided to protect the surface of the odor generator 40. This is to prevent the odor generator 40 from being touched accidentally when the toner containers 4a to 4d are handled and to prevent other substances from adhering to the odor generator 40. In the protection member 47 shown in FIG. 14, slits 47a are formed and the odor substance diffuses through the slits 47a. In the protection member 47 shown in FIG. 15, the odor generator 40 is covered with a nonwoven fabric 47b and the odor substance diffuses through the nonwoven fabric 47b. If as shown in FIG. 2 a shutter 41 that can open and close the odor generator 40 is attached to the toner containers 4a to 4d, the shutter 41 functions also as the protection member 47.

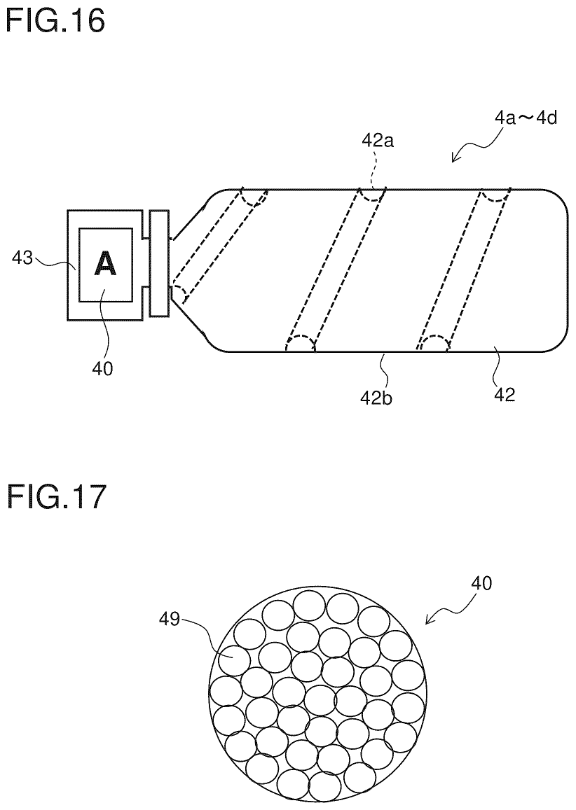

FIG. 16 is a top view of the toner containers 4a to 4d in which a label-type odor generator 40 is arranged on the fixing portion 43. In the odor generator 40, an odor substance (for example, an oil-based fragrance) is encapsulated in microcapsules of about 1 to 5 μm and a label having a letter or symbol printed on it with ink having the microcapsules dispersed in it is attached to the fixing portion 43 of the toner containers 4a to 4d. The shell (outer layer) of the microcapsules can be gelatin film, melamine film, urethane film, or the like, among which, in terms of ease of handling, urethane film is preferable.

On the container mounting portion 101, a rubbing member (not shown) is provided so that, when the toner containers 4a to 4d are inserted into the container mounting portion 101, the microcapsules are crushed by the rubbing member and the odor substances are diffused. With this configuration, the odor generator 40 can be fabricated easily by printing it simply with ink containing microcapsules. There is no need for the sealing member 44 (see FIG. 2) required for preventing the diffusion of the odor substance during transportation and storage of the toner containers 4a to 4d, and the odor substance can be changed easily by simply changing labels. This permits the odor generator 40 to be used more conveniently.

When the sealing member 44 for preventing the diffusion of the odor substance is used, if the sealing member 44 peels off during transportation or storage, the level of the odor substance decreases. Thus, when the toner containers 4a to 4d with the sealing member 44 peeled off are mounted in the container mounting portion 101, one may mistake that used toner containers 4a to 4d are mounted. By contrast, when the label-type odor generator 40 is used, there is no such a risk.

Instead of the sealing member 44, capsules may be used. Specifically, the odor generator 40 itself is configured as a collection of capsules in which the odor substance is encapsulated and, when the odor sensor 50 senses the odor, the capsules are broken to diffuse the odor substance. The capsules are made of a resin material that is impermeable to the odorous substance.

FIG. 17 is a schematic diagram of an odor generator 40 configured with superabsorbent beads 49. The superabsorbent beads 49 can be formed of, for example, a cross-linked polyacrylate. Impregnating the superabsorbent beads 49 with the odor substance enhances retention capacity for the odor substance. Furthermore, adding a polyolefin resin to resin pellets containing the odor substance and molding them into a bar shape with a three-dimensional structure permits the odor substance to bleed across the surface of the three-dimensional structure so as to volatilize from the surface of the three-dimensional structure for a long period of time.

Based on a decrease of the odor substances sensed by the odor sensor 50, it is also possible to predict the state of the toner in the toner containers 4a to 4d. The odor substance tends to diffuse easily when the ambient temperature is high and tends to diffuse easily also when the ambient humidity is low. That is, the higher the temperature and the lower the humidity in the environment, the easier the odor substance diffuses and the faster the odor substance decreases. By contrast, the lower the temperature and the higher the humidity in the environment, the slower the odor substance decreases. Depending on the type of toner external additive, in a high-temperature and low-humidity environment, the toner external additive is likely to be buried or separated and this tends to degrade the performance of toner. By contrast, in a low-temperature and high-humidity environment, it is easy to maintain the performance of toner. Thus, based on the degree of decrease of the odor substances, the state of the toner can be predicted to some extent.

If the odor sensor 50 cannot sense the odor substance, for example, the odor sensor 50 may be broken, or the sealing member 44 covering the odor generator 40 on the toner containers 4a to 4d may not have been peeled off. To cope with that, if the odor substance cannot be sensed when the new toner containers 4a to 4d are mounted, it is preferable to indicate a notification on the liquid crystal display portion 81 (see FIG. 6) to prompt the user to make sure to have peeled off the sealing member 44.

If the odor generator 40 can retain the odor substance for a long period of time, by letting it retain an odor substance that is fragrant, insect-repellent, deodorizing, or the like, it is possible to achieve secondary effects such as an aroma effect, insect-repellent effect, deodorizing effect or the like. If the odor substance is added to toner, the effect is obtained only during printing, but if the odor substance is retained in the odor generator 40 on the toner containers 4a to 4d, the odor substance can be always diffused.

Odor substances with an insect-repellent effect include linalool, terpineol, and allylic esters. The odor substances with a deodorizing effect include stabilized chlorine dioxide, sesquiterpene, and green-tea catechin. In the color printer 100, a fan (not shown) is arranged for cooling inside the apparatus and this fan is driven to diffuse the odor substance around the installation site.

The present disclosure is not limited to the above embodiments and can be carried out with any modifications made without departure from the spirit of the present disclosure. For example, in the above embodiments, the toner containers 4a to 4d that supply toner to the development devices 3a to 3d are identified by a method employing the odor generator 40 attached to the toner containers 4a to 4d and the odor sensor 50 provided in the container mounting portion 101; however, the toner storage containers to be targeted for identification are not limited to the toner containers 4a to 4d.

For example, a development cartridge having the toner containers 4a to 4d and the development devices 3a to 3d integrated together and a drum unit having also the photosensitive drums 1a to 1d integrated in it are also included in the toner storage containers to be targeted for identification by the identification method using the odor generator 40 and the odor sensor 50 according to the present disclosure.

The present disclosure is not limited to development devices 3a to 3d that use two-component developer containing toner and magnetic carrier, but is also applicable to image forming apparatuses including development devices employing a one-component development method that use magnetic one-component developer containing only magnetic toner.

The present disclosure is applicable not only to the color printer 100 like the one shown in FIG. 1 but also to any other types of image forming apparatuses such as monochrome printers, monochrome copiers, color copiers, digital multifunction peripherals, and facsimile machines, that is, image forming apparatuses having the toner storage container that is removably mounted in.

The present disclosure can be used in image forming apparatuses including a toner storage container that is removably mounted in the image forming apparatus. Based on the present disclosure, it is possible to provide an image forming apparatus that can identify the type of toner storage container easily in a manner difficult to imitate.

What is claimed is:

1. An image forming apparatus comprising:
an image forming portion that includes an image carrying member and a development device that develops an electrostatic latent image formed on the image carrying member into a toner image, the image forming portion forming the toner image based on an image data;
a toner storage container that stores toner for forming the toner image, the toner storage container being removably mountable in a main body of the image forming apparatus;
an odor generator that is provided on the toner storage container, the odor generator carrying an odor substance;
an odor sensor that is provided in the main body of the image forming apparatus, the odor sensor sensing the odor substance diffusing from the odor generator; and
a control portion that identifies a type of the toner storage container based on the odor substance sensed by the odor sensor.

2. The image forming apparatus according to claim 1, wherein
the main body of the image forming apparatus has a mounting portion in which the toner storage container is mounted, and
when the toner storage container is mounted in the mounting portion, the toner generator passes across, or stops at, a position facing the odor sensor.

3. The image forming apparatus according to claim 2, wherein
the mounting portion includes an odor retention portion that, with the odor generator and the odor sensor facing each other, surrounds a space including the odor generator and the odor sensor.

4. The image forming apparatus according to claim 1, wherein
the toner storage container includes a shutter that is movable between a closed position in which the shutter covers the odor generator and an open position in which the shutter leaves the odor generator open.

5. The image forming apparatus according to claim 1, wherein
the toner storage container, before being mounted in the main body of the image forming apparatus, seals a space including the odor generator with a sealing member formed of a material that is peelable and impermeable to the odor substance.

6. The image forming apparatus according to claim 1, wherein
when not sensing the odor substance, the odor sensor is arranged at a standby position not facing the odor generator and, only when sensing the odor substance, the odor sensor moves to a sensing position facing the odor generator.

7. The image forming apparatus according to claim 1 further comprising:
a storage portion that stores information on the odor substance sensed by the odor sensor; and
an output portion that outputs the information on the odor substance stored in the storage portion.

8. The image forming apparatus according to claim 7, wherein
the control portion identifies a type of the toner storage container in use based on the information on the odor substance stored in the storage portion and changes an image forming condition in the image forming portion according to the identified type of the toner storage container.
